(19) United States
(12) Patent Application Publication
(10) Pub. No.: US 2013/0185110 A1
(43) Pub. Date: Jul. 18, 2013

(54) SYSTEM FOR COMPLETING COMMUNITY SERVICE HOURS ONLINE

(71) Applicant: ADAM C. YOUNG, SAN DIEGO, CA (US)

(72) Inventor: ADAM C. YOUNG, SAN DIEGO, CA (US)

(21) Appl. No.: 13/787,685

(22) Filed: Mar. 6, 2013

Related U.S. Application Data
(63) Continuation-in-part of application No. 13/165,691, filed on Jun. 21, 2011.

(51) Int. Cl. G06Q 10/06

(52) U.S. Cl. CPC G06Q 10/063114
USPC 705/7.15

(57) ABSTRACT

A computer system for tracking online community service. The system includes receiving an assignment of community service for a citizen. The system tracks the online community service activity of the citizen. And, the system receives approval from a charity that the assigned community service has been completed by the citizen because of the tracked online community service.

### CROSS-REFERENCE TO RELATED APPLICATIONS

This application is a continuation-in-part application of U.S. patent application Ser. No. 13/165,691, titled Online Community Service, filed Jun. 21, 2011.

### BACKGROUND OF THE INVENTION

1. Field of the Invention

This invention relates generally to a system for tracking online community service activities of an individual and, more particularly, to a system for tracking the completion of assigned community service hours as they are being performed.

2. Discussion of the Related Art

Present day community service assigned by an authoritative body is traditionally defined as a person volunteering time to a charitable organization for an agreed on period of time to satisfy some type of obligation to society or the authoritative body. The activities accomplished during the assigned volunteer time is at the sole discretion of the charitable organization.

It is increasingly difficult for citizens to complete the required community service through traditional charity outlets due to rising liability insurance costs and a poor economy. Further, a citizen can find it difficult to fulfill the desired community service without interrupting their work schedule.

Most authoritative bodies that order community service at a charitable organization do not require the community service be done at any particular time, but the charity will require supervision of the citizen, which limits when the citizen can do the community service.

What is needed is a way for the citizen to do their assigned community service without impinging on their ability to earn money and without incurring liability on the charity.

### SUMMARY OF THE INVENTION

In accordance with the teachings of the present invention, a computer system for tracking the online completion of community service is described. The computer system facilitates completion of an assigned community service, be it traditional court ordered community service or otherwise, by tracking the community service using an electronic device that communicates over a network to the computer system. The system matches individuals that have been assigned community service by an authoritative body with a charitable organization that will sponsor their assigned community service.

The computer system connects citizens with a charity. The computer system provides the individual with tasks that, when completed, fulfills their assigned community service. While the citizen participates in the tasks, the computer system records the volunteer tasks that are completed. Later the computer system can be accessed to verify the volunteer tasks. The tasks assigned to the citizen can vary; however, they are all delivered or tracked online. All the directions and materials associated with the tasks can be delivered electronically, or by other mechanisms.

Additional features of the present invention will become apparent from the following description and appended claims, taken in conjunction with the accompanying drawings.

### BRIEF DESCRIPTION OF THE DRAWINGS

Having thus described the invention in general terms, reference will now be made to the accompanying drawings where:

FIG. 1 is a block diagram of a networked computer system;

FIG. 2 is a block diagram showing three users of an Online Community Service System;

FIG. 3 is a flowchart illustrating an embodiment with the computer system notifying the authoritative body of the completion of the community service;

FIG. 4 is a flowchart illustrating an algorithm that can enable the computer system to track online community service time; and

FIG. 5 is a flowchart illustrating an embodiment that provides the citizen with a verification letter to take to the court.

### DETAILED DESCRIPTION OF THE EMBODIMENTS

The following discussion of the embodiments of the invention directed to a computer system for tracking online community service will now be described more fully hereinafter with reference to the accompanying drawings, in which detailed embodiments are shown and described. These embodiments should not be construed to limit the scope of this disclosure in any way; rather, these embodiments are provided by way of example so that this disclosure will satisfy applicable legal requirements, and is in no way intended to limit the invention, its applications or uses.

For this specification, online community service includes activities that a citizen does online or that are tracked online and that a charity deems worthy of community service credit. In this specification, the citizen is also known as a volunteer or a user and can refer to any individual who needs to or wants to do community service. The citizen could be a citizen of the United States or not. A charity is a charitable organization, non-profit organization, community service outlet or other similar organization. For this specification, the terms “online volunteering” and “online community service” are synonymous, and the terms “Community service tasks” and “community service activity” are synonymous.

An authoritative body includes any authoritative or accredited body, Federal Court System, District Court System, Circuit Court system including Circuit Court of Appeals, Supreme Court, Criminal Court, Bankruptcy Court, Tax Court, Court of Veterans Appeals, State Court System, Probate Court, Family Court, Traffic Court, Juvenile Court, Small Claims Court, Municipal Court, Magistrate Judge, Trial Court, Criminal Court, Public School System, Private School System, Scholarship Board, Probation Officer, Parole Officer, Officer of the Court, Juvenile Deferment Program, Deferment Program, Probation Program, Judicial Worker, Judge, District Attorney, Federal Attorney, Arbitrator, Mediator, Councilor, Case Worker, Magistrate, Clerk of the Court, Legal Aid, any similar entity, any entity that desires that an individual does volunteering or its agents. The authoritative body is also known as the referring entity, overseeing entity or authoritative entity. An individual wanting to participate in online volunteer could assign himself or herself community service, in which case the individual would be the authoritative body.

The community service can be given in lieu of fines, in lieu of jail time, in lieu of driver's license points and or suspensions, other consequences, or any other reason that the authorative body decides on.

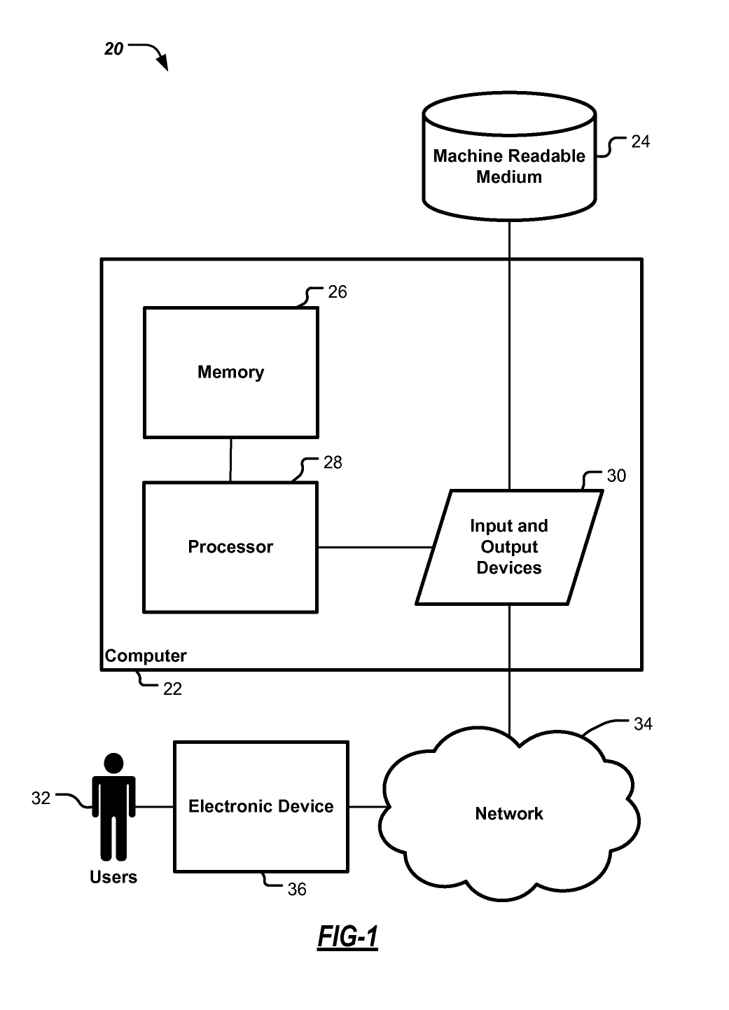

FIG. 1 illustrates a networked computer system 20 that includes a machine readable medium 24, a computer 22 and a user 32 that can access the computer 22 via an electronic device 36 through a network 34. The computer 22 includes a memory 26, a processor 28, and input and output (I/O) devices 30. The machine readable medium 24 could be a disk drive, thumb drive, CD, DVD or other device capable of being read by the processor 28 through the I/O devices 30. The machine readable medium 24 contains program instructions and data where the program instructions and data can be run on the processor 28 with the memory 26 to create the functionality described herein. The processor 28 communicates to the user 32, using the I/O devices 30, the network 34 and the electronic device 36. The processor 28 can run a program loaded from the machine readable medium 24 or loaded through the I/O devices 30 from the network 34. The processor 28 and the memory 26 are configured into a special purpose computer system that implements an online community service system, OCS system that is described and claimed in this specification. Although a particular computer architecture has been detailed in this specification, there are variations and alternate approaches that could provide the infrastructure needed to create the special purpose machine of the OCS system.

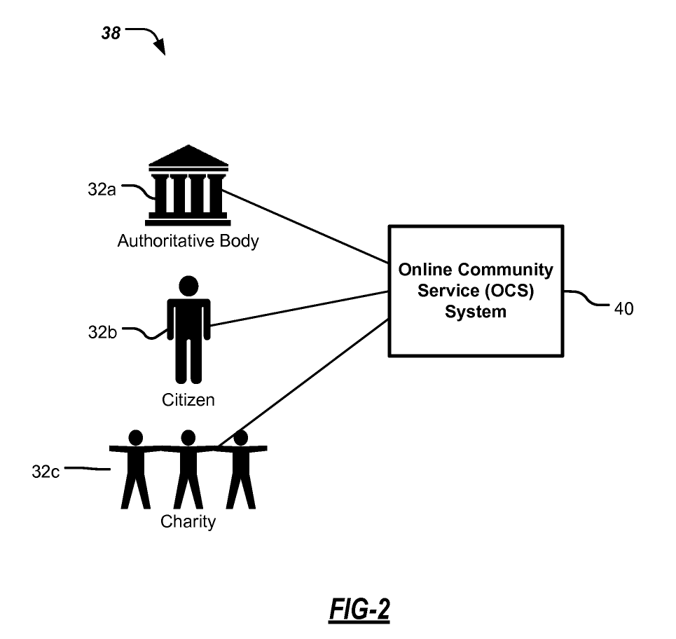

FIG. 2 is a high-level user interactive system diagram 38 showing the users 32 of the OCS system 40 categorized into three types of users 32a-c. More particularly the user roles are for an authoritative body 32a, a citizen 32b and a charity 32c.

The OCS system 40 could be built on or utilize technology such as web/internet portal, website, http, web 2.0 technology, internet pages, hosted internet content, internet media, streaming media, programs designed to run in a network computer environment or equivalent technology, or the evolution of such technologies that develop in the future. The OCS system 40 could be designed to allow access by the general public. The OCS system 40 could be secured by use of user-defined information, wherein users 32 input designated credentials to access secured or unsecured content. Examples of such credentials would be a user identification (user-ID) and a password.

The network 34 can be the internet, other online network, mobile phone network or other type of interconnected set of devices, where the internet is the interconnecting set of networks that cover the world, also known as the World Wide Web. The network 34 could be secured or unsecured. The network 34 could be wireless, wired or a combination of both that transmits various standard protocols or proprietary protocols. The network 34 could be an interconnected network of devices that transmits by electronic signal to a single user or a group of users. The OCS system 40 can communicate over the network 34 to and from the charity 32c and to and from the citizen 32b on behalf of the charity 32c by means of electronic documents or other signals traveling on the network 34.

The electronic device 36 could be a personal computer, PC, that is running a web browser or other type of hyper text transfer protocol (HTTP) software accessing the OCS system 40 through a universal record locator (URL). The electronic device 36 could also be a computer, laptop, notebook, mobile phone, tablet computer or similar device, any other device that can provide two-way communication from the user 32 to the OCS system 40, or any other type of input device that the user 32 can interact with and is capable of communication over the network 34 to the OCS system 40. The electronic device 36 could be connected by wireless signal or cable to the network 34.

### Embodiment One

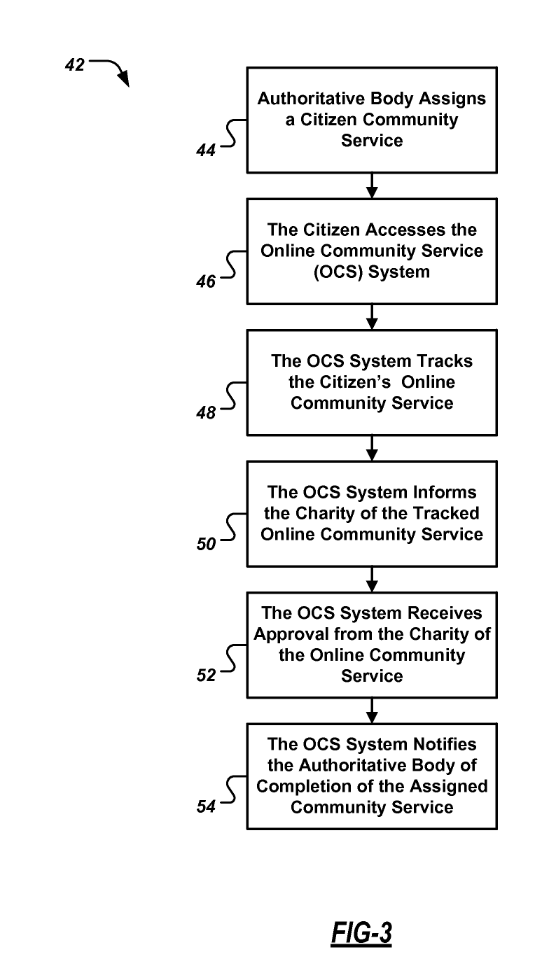

FIG. 3 is a flowchart 42 of one possible embodiment where the authoritative body 32a assigns community service to the citizen 32b, then the citizen's online volunteering activity is tracked by the OCS system 40 and reported to the authoritative body 32a when complete. The process starts at box 44 where the authoritative body 32a assigns the citizen 32b community service. The assigned community service is usually specified in the form of a number of hours or days, but could be specified in other time increments or not denominated in time, for example, feed 100 people in a soup kitchen. If the authoritative body 32a is a court, then the assigned community service could be required by law. Next, at box 46 the citizen 32b accesses the OCS system 40 and establishes a user account. Once the user account has been established, then the citizen 32b can be recognized, and their online community service activities can be tracked by the OCS system 40 at box 48. At box 50, the tracked online volunteering activities can be shared with the charity 32c for them to review and approve. At box 52, the OCS system 40 receives the approval from the charity 32c of the tracked community service activities. Finally, at box 54 the OCS system 40 notifies the authoritative body 32a of the completion of the assigned community service.

At the box 46, the citizen 32b accesses the OCS system 40 and establishes a user account by means of the electronic device 36 that works over the network 34 to communicate to the OCS system 40. The OCS system 40 could be made accessible to the citizen 32b on any day and time from the convenience of their home or anywhere using the electronic device 36.

The OCS system 40 provides electronic monitoring of the citizen 32b at the box 48 while the citizen 32b is completing tasks for the charity 32c, where the tasks could have been assigned by the charity 32c. The tasks tracked at the box 48 could be various tasks including, but not limited to, education, mentoring, communicating to those in need, creation of documents, fund raising, any other task the charity 32c deems worthy of discharging the citizen's assigned community service obligation, or traditional volunteering where the OCS system 40 helps track online the traditional community service activity.

The educational tasks tracked at the box 48 can be delivered in any form, for example, written, electronic, virtual, audio, video, streaming media, interactive, lecture, class, courses in coursework (in groups or individual) with course materials delivered by electronic means (such as download) or physical means. If delivered in physical means, then an electronic means is used for verifying the materials were read, for example, with an online test. The education can be with or without testing/quizzing. The education can be with or without some sort of participation required. The education can be with or without a review process. The educational materials, coursework, course materials, classes, courses and documents are defined as materials that contain information in any form that will improve the knowledge or capability of the citizen 32b or a group of the citizens 32b. The citizens 32b can be given access to educational materials. Delivery of the educational materials to the citizen 32b can be through the network 34 to the electronic device 36.

Mentoring tasks tracked at the box 48 could involve video chat, text chat, email correspondence or correspondence by any electronic method involving communication through the network 34, where the communication is between a mentor and protégé, or groups of mentors and protégés and is done through or facilitated by the OCS system 40.

Communicating to those in need at the box 48 could be tutoring, counseling, playing games with the elderly or the disabled. The OCS system 40 could facilitate any type of service that fosters communicating with someone else who is elderly, disabled or special needs, or similar individuals, be it individuals that are on their own or in someone else's care. The communication could be through a web cam, chat room, email communication or any type of electronic communication.

Writing and proofing tasks tracked at the box 48 could facilitate the writing or proofing of documents where the documents are educational or other types of written documents. The OCS system 40 could facilitate creating, filing or sorting digital documents. The OCS system 40 could facilitate creating something visual or written other than documents, like a web page. The creation of documents could be creating or reviewing any electronic documents or intellectual property. The information can be delivered to the user 32 by means of electronic documents sent via the network 34 where the source of the information could be the charity 32c, be it an electronic document directly from the charity 32c or derived from information received from the charity 32c.

The tasks tracked at the box 48 could be activities related to online fundraising, for example, activities related to driving traffic to the charity 32c's website, collecting funds from the internet, social networking, or posting of web links to bring attraction to the charity 32c or a campaign that the charity 32c is running. The electronic device 36 could be a phone and the citizen 32b could talk on the phone for charity 32c purposes, such as making fund raising calls or calling people designated by the charity 32c for other purposes. The calls could be to solicit donations or raise funds or spread the message of the charity 32c. The citizen 32 could do the calls over their computer through voice over IP, Skype or similar technology, or the calls could be made using a traditional wired phone, with tracking accomplished with some of the ways described below.

The community service task that is done at the box 48 could be anything to benefit the charity's finances or mission. For example, activities that improve, complete, further or satisfy the charity's mission, could be community service tasks.

Even traditional volunteer activities could be tracked online at the box 48 utilizing certain features of the electronic device 36. For example, the OCS system 40 could use the electronic device 36 to determine the citizen's location, for example, by GPS coordinates sent from the electronic device 36, which could be used to verify the volunteer is likely doing their activity by confirming their presence at the community service location. The OCS system 40 could use the electronic device 36, for example a cell phone, to take periodic pictures for verification that the citizen 32b is participating in the volunteer activity.

At the box 48, any delivery of the task may be through the network 34 or in physical form. If the delivery of the task is done in physical form, then the tracking of task completion would be through the electronic device 36 using the network 34 to communicate with the OCS system 40. For example, if the educational material was delivered in physical form, then the tracking could be done by using the electronic device 36 communicating over the network 34 to the OCS system 40 to answer questions about the educational material.

At the box 48, the OCS system 40 can keep track and record the time segments the citizen 32b spends doing online community service. For example, if the electronic device 36 is a PC then the OCS system 40 could track mouse movements, using Java script or some other type of programming language to make sure that the citizen 32b is still using the PC for the volunteer activity.

The OCS system 40 could receive images from the electronic device 36, for example, the electronic device 36 could be a cellular phone with a built in camera or a PC with a built in web-cam. When the electronic device 36 is a PC with a web-cam, then the OCS system 40 could periodically take pictures of the citizen 32b in front of the PC to ensure the citizen 32b is in front of the PC and participating in the community service activity.

At the box 48, the OCS system 40 can track tasks by means of a timer, clock or counting device, counting down or up, forward or backward in sequential standard or non-standard or non sequential standard or non-standard measurements of time. Information regarding the tracked time can be stored in an electronic facility for later recall and transmission. The storage could be secured through encryption or other appropriate technology.

The OCS system 40 could receive an acknowledgement of the citizen's effort from the person who was helped by the citizen 32b. The OCS system 40 could prompt the person who was helped for their feedback and acknowledgment of the citizen's activities.

At the box 50, the tracked online volunteering activities can be shared with the charity 32c for them to review and approve. At box 52, the OCS system 40 receives the approval of the volunteer activities from the charity 32c.

Finally, at the box 54, the OCS system 40 notifies the authoritative body 32a of the completion of the assigned community service and provides the citizen 32b with whatever information or documentation is necessary for the citizen 32b to show they have completed the assigned community service. The OCS system 40 can track and organize the citizens 32b that are sent to it from the authoritative body 32a. The OCS system 40 can allow the authoritative body 32a to oversee the citizen 32b, review the citizen's progress and provide access to all the information the OCS system 40 has collected about the tracked community service activity and the information and decisions that the charity 32c has provided relative to the citizen 32b.

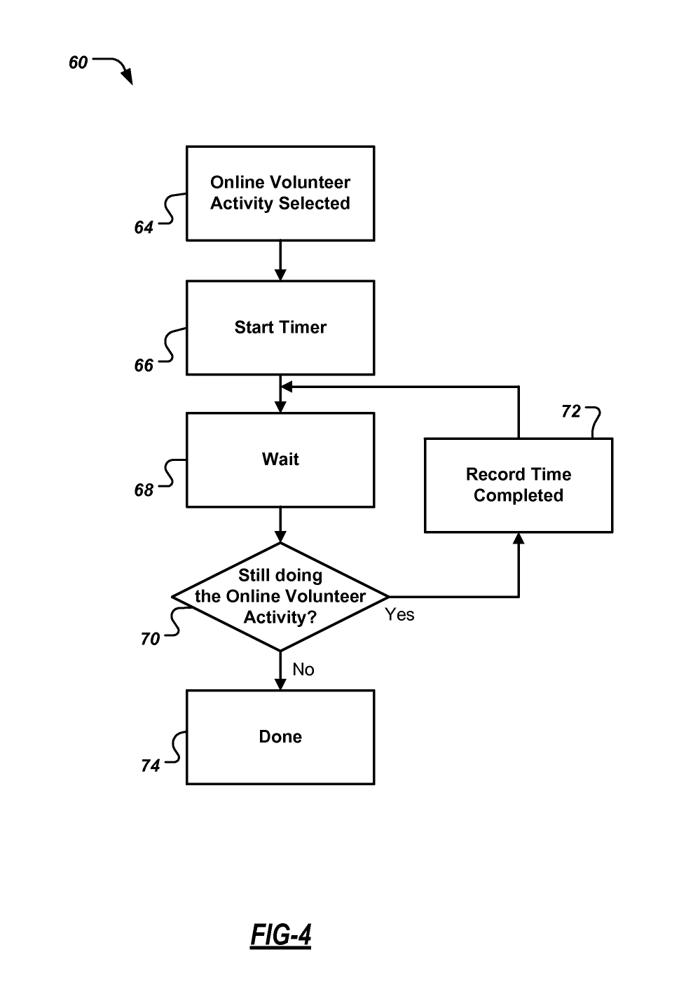

FIG. 4 shows a flowchart 60 that depicts details for the box 48 from FIG. 3 showing one possible algorithm that could be used to track a citizen's online community service activity where the activity is specified in an amount of time. The algorithm starts at box 64 where the citizen 32b selects an online community service activity, for example, the citizen 32b could choose to watch an educational video. Next, at box 66, a timer is started, and then at box 68 the algorithm waits for some amount of time to pass, for example, 2-7 minutes. After that time has passed, then at decision diamond 70 the algorithm determines if the citizen 32b is still doing the online community service activity, or if the citizen 32b is no longer participating. One way to check if the citizen 32b is still participating would be to prompt the citizen 32b if they are still there. If the citizen 32b is still doing the volunteer activity, then the algorithm goes to box 72 and records the amount of time the citizen 32b spent doing online community service. The amount of time recorded could be since the timer started or since the last successful check of the citizen's participation. Then the algorithm returns to the box 68 and waits again. If at the decision diamond 70 the algorithm determines the citizen 32b is no longer participating, then the algorithm proceeds to box 74 and the algorithm for tracking the online community service is done. In a variation on the flowchart 60, the recording of time that is done at the box 72 could instead only be done once, at the end of the algorithm at the box 74 when the citizen 32b is found to no longer be participating in the online community service. The tracking can be done with this algorithm running on the electronic device 36 or the algorithm could run on the computer 22 communicating over the network 34.

### Embodiment Two

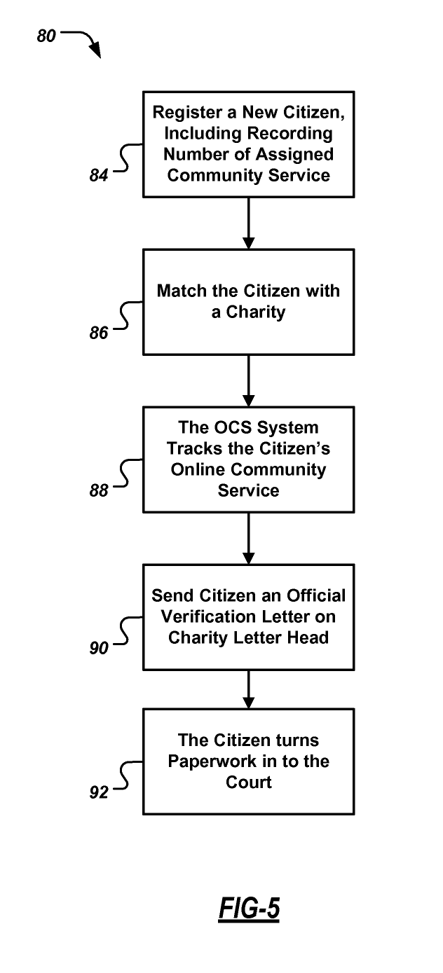

FIG. 5 is a flow chart 80 that provides another embodiment where the citizen 32b registers for tracking of online community service, the citizen's community service is tracked and paper verification for a court is provided. The flowchart 80 starts at box 84 where the citizen 32b registers. Registration includes providing the amount of assigned community service. Next, at box 86 the citizen 32b is matched with a charity. Then, at box 88, which has the same functionality as the box 48 in FIG. 3, the OCS system 40 tracks the citizen's online community service. Once the assigned community service is complete, then at box 90, the OCS system 40 sends the citizen 32b an official verification letter on charity letterhead after the charity 32c has approved the tracked online community service. Finally, at box 92 the citizen 32b takes the official verification letter to the authoritative body 32a to verify that the assigned community service was completed, where the authoritative body 32a could be a court.

Matching of the citizen 32b with a charity at the box 66 means to place, connect, assign or somehow create a relationship between the citizen 32b and the charity 32c. For example, the OCS system 40 could provide a list of charities that the citizen 32b could do community service for, and then the citizen 32b could make a selection from the list. The OCS system 40 could then issue to the citizen 32b tasks to complete for the assigned community service to be rendered complete. The match could be established by various factors instead of being selected by the citizen 32b, for example, based on shared interests, or what is geographically closest to the citizen 32b. The OCS system 40 could provide the match at the box 86 by various means, for example, automatic placement, electronic placement, manual placement, human placement or other means.

The OCS system 40 can facilitate fund raising donations for the charity 32c in lieu of volunteer hours to complete assigned community service. A monetary exchange can be initiated by the citizen 32b using the OCS system 40. The monetary exchange can happen with the citizen 32b communicating through the network 34 to the computer 22. The charity 32c sponsoring the volunteer can receive some or all of the monetary exchange and in return provide credit for community service. The community service credit can be provided to the citizen 32b for a specific period of time or for a specific community service credit in exchange for a monetary instrument. Appropriate authoritative body approval could be facilitated by the OCS system 40.

The OCS system 40 could require a combination of monetary compensation and online-volunteer time. Where a portion of the monetary compensation is provided to the charity 32c. The monetary compensation could be correlated to the time needed to review and approve the online-volunteer hours. The OCS system 40 could take the money received from the citizen 32b and find a charity willing to accept a portion of the monetary compensation in exchange for their time reviewing and approving the online community service.

The OCS system 40 removes all liability from the charity 32c and time constraints from the citizen 32b and the charity 32c. The technology supervises the citizen 32b at all times and maintains a secure record of all their activities and the time they spent online volunteering. By removing human supervision from the equation and allowing the citizens 32b to volunteer via electronic means, the OCS system 40 provides a great service to society.

Allowing the citizens 32b to complete their assigned community service online with the use of modern technology enables the citizens 32b to fulfill their obligation to society in a manner that is convenient to their schedule so completing the assigned community service does not interrupt their work schedule, that way they continue to be productive citizens. The OCS system 40 enables an individual to fulfill their debt to society, which a court order has indicated, by performing online community service.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

Give all terms used in the claims their broadest reasonable construction and their ordinary meaning as understood by those skilled in the art. Use of the singular articles such as “a”, “the”, “said”, etc. should be read to recite one or more of the indicated elements.

What is claimed is:

1. An online community service system comprising:
a computer system with a processor and a memory executing instructions that:
receives an assignment of community service for a citizen;
tracks online community service activity of the citizen; and
receives approval from a charity that the assigned community service has been completed by the citizen because of the tracked online community service activity.

2. The online community service system of claim 1 where the assignment is received from the citizen.

3. The online community service system of claim 1 where the assignment is received from an authoritative body.

4. The online community service system of claim 3 where the authoritative body is a court.

5. The online community service system of claim 3 further comprising notifying the authoritative body that the citizen has completed the assigned community service.

6. The online community service system of claim 1 where the assigned community service is measured in time, and the system tracks the community service activity by storing the amount of time the citizen spends doing the community service activity.

7. The online community service system of claim 6 where the time is tracked by starting a timer when the community service activity is started by the citizen, then periodically prompting the citizen to respond and when the citizen does respond, storing the amount of time the citizen has been doing the community service activity.

8. The online community service system of claim 1 where the system tracks the community service activity by sending instructions to an electronic device and receiving information from the electronic device, where the received information helps verify that the citizen is doing the community service activity.

9. The online community service system of claim 1 where the community service activity is an educational community service activity.

10. The online community service system of claim 9 where the educational community service activity is accomplished by delivering educational material in page or screen format that are printed or online and then tracks the educational community service activity by having the citizen take a test online about the educational material.

11. The online community service system of claim 10 where the educational community service activity is done by the citizen watching an educational video, and where the assigned community service is measured in time, and the system tracks the community service by storing the amount of time the citizen spends doing the educational community service activity, and where the time is tracked by starting a timer when the educational community service activity is started by the citizen, then periodically prompting the citizen to respond and when the citizen does respond, storing the amount of time the citizen has been participating in the educational community service activity.

12. The online community service system of claim 1 further comprising the charity receiving money for their approval of the tracked online community service activity.

13. An online community service system comprising:
a computer system with a processor and a memory executing instructions that:
receives information about assigned community service that a citizen is to complete;
provides a list of online community service activities for the citizen to select from;
receives a selected online community service activity from the list;
tracks the online community service activity of the citizen; and
receives approval from a charity that the tracked online community service activities of the citizen has completed the assigned community service.

14. The online community service system of claim 13 where the assigned community service is measured in time.

15. The online community service system of claim 14 where the time is tracked first by starting a timer, then periodically prompting the citizen to respond and when the citizen does respond, storing the amount of time since the timer was started or since the citizen last responded.

16. The online community service system of claim 13 where the online community service activity is an educational community service activity.

17. The online community service system of claim 13 further comprising providing the citizen with verification of the completed assigned community service.

18. The online community service system of claim 17 where the verification is a letter on charity letterhead.

19. An online community service system comprising:
a computer system with a processor and a memory executing instructions that:
receives money to track online community service activity of a citizen;
tracks online community service activity of the citizen;
provides information to a charity about the tracked online community service activity for the charity to review;
receives approval from the charity that the tracked online community service activity has been verified; and
reports information about the charities approval of online community service activity that can be used to calculate a payment for the charity.

20. The online community service system of claim 19 where the assigned community service activity is measured in time, and the system tracks online community service by recording the time the citizen is doing the online community service activity.

21. The online community service system of claim 19 where the time is tracked first by starting a timer, then periodically prompting the citizen to respond and when the citizen does respond, recording the amount of time since the timer was started or since the last response.

22. The online community service system of claim 19 where the online community service activity is educating the citizen.

23. The online community service system of claim 19 further comprising providing the citizen with verification of the completion of the assigned community service.
